(19) United States
(12) Patent Application Publication
(10) Pub. No.: US 2015/0012250 A1
(43) Pub. Date: Jan. 8, 2015

(54) CLUSTERING BASED CONTINUOUS PERFORMANCE PREDICTION AND MONITORING FOR SEMICONDUCTOR MANUFACTURING PROCESSES USING NONPARAMETRIC BAYESIAN MODELS

(71) Applicant: International Business Machines Corporation, Armonk, NY (US)

(72) Inventor: Zhiguo Li, Yorktown Heights, NY (US)

(73) Assignee: International Business Machines Corporation, Armonk, NY (US)

(21) Appl. No.: 14/026,650

(22) Filed: Sep. 13, 2013

Related U.S. Application Data
(63) Continuation of application No. 13/934,398, filed on Jul. 3, 2013.

(51) Int. Cl. G06F 17/50

(52) U.S. Cl. CPC G06F 17/5009
USPC 703/2; 703/6

(57) ABSTRACT

There is provided a method for modeling a semiconductor manufacturing process. The method receives trace data, process variables data and metrology data, obtained during the semiconductor manufacturing process. The method creates, based on the received trace data, the received process variables data and the received metrology data, a performance model of the semiconductor manufacturing process. The created performance model captures nonlinearity characteristics of the semiconductor manufacturing process. The method predicts, based on the created performance model, future values of the received metrology data. The method also detects nonstationarity characteristics of the semiconductor manufacturing process by detecting a significant change in the semiconductor manufacturing process.

### CROSS REFERENCE TO RELATED APPLICATION

This application is a continuation of U.S. patent application Ser. No. 13/934,398 filed Jul. 3, 2013 the entire content and disclosure of which is incorporated herein by reference.

### FIELD OF INVENTION

This disclosure relates generally to modeling a semiconductor manufacturing process, and particularly to modeling nonlinearity and nonstationarity characteristics of a semiconductor manufacturing process.

### BACKGROUND

A Gaussian process is a generalization of the Gaussian probability distribution. Whereas a probability distribution describes random variables which are scalars or vectors (for multivariate distributions), a stochastic process governs properties of corresponding functions. A Gaussian Process Model (GPM) is a data interpolation model based on a Bayesian inference method, and it can be used to infer a relationship between a set of input parameters and a set of targets, or outputs, parameters. Mixture model infers attributes of a population from samples without disclosing identities of the samples. In Dirichlet Process (DP), an input distribution is a random distribution and an input parameter is a positive real number. A draw from Dirichlet process returns a random distribution including values drawn from the input random distribution. By replacing random variables with random probability measures drawn from a DP, this results in a nested Dirichlet process (nDP). Temporal Dirichlet process mixture model (TDPMM) is a generalization of DP that automatically grows the number of clusters as input data grows. TDPMM is also known as a dynamic clustering. nDP handles clustering of probability distributions and multilevel clustering simultaneously. TDPMM handles evolutionary clustering (i.e., dynamic clustering) where clustering of input data changes over time due to evolving nature of these input data. Dynamic Linear Model (DLM) is used to model and predict time-series data based on explanatory factors (i.e., characteristics of populations) through a pair of equations—an observation equation and an evolution/system equation. A Bayesian inference method is a method used to update a probability estimate as additional input or additional information becomes available.

A “nonparametric” model assumes that a corresponding model structure is not fixed. Rather, the model evolves as more input data becomes available. DP, nDP, TDPMM, and GPM are nonparametric Bayesian models. “Multivariate” statistics is a form of statistics concurrently observing and analyzing a plurality of outcome variables. “Multivariate” normal distribution is a generalization of one-dimensional normal distribution to higher dimensions.

Trace data is data recorded from many different sensors during one or more processing steps in a semiconductor manufacturing process. In other words, trace data includes signals measured from the sensors mounted on manufacturing tools in semiconductor processing. A process of semiconductor manufacturing often requires hundreds of sequential steps, each one of which could lead to a yield loss. Consequently, maintaining product quality in a semiconductor manufacturing facility often requires a strict control of hundreds or even thousands of process variables. The process variables are the variables which can be adjusted by a control computing system to ensure a product quality and yield rate of semiconductor chips manufactured by the semiconductor manufacturing process. Metrology data is measurement data collected from products (e.g., semiconductor chips, etc.), while the trace data is sensor data collected from manufacturing tools and chambers.

### SUMMARY

There are provided a method, a system and a computer program product for modeling a semiconductor manufacturing process. The system receives trace data, process variables data and metrology data, obtained during the semiconductor manufacturing process. The system creates, based on the received trace data, the received process variables data and the received metrology data, a performance model of the semiconductor manufacturing process. The created performance model captures nonlinearity characteristics of the semiconductor manufacturing process. The system predicts, based on the created performance model, future values of the received metrology data of products manufactured in the semiconductor manufacturing process. The system detects nonstationarity characteristics of the semiconductor manufacturing process.

The system updates the created performance model when a significant change is detected in the semiconductor manufacturing process.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 illustrates a flowchart run in order to model a manufacturing process;

FIG. 2 illustrates a system diagram run in order to model a manufacturing process;

FIG. 3 illustrates example computing systems run the method shown in FIG. 1;

FIG. 4 illustrates an example first-type cluster, an example second-type cluster, and an example third-type cluster.

### DETAILED DESCRIPTION

With rapid growth of sensor and measurement technologies, an abundance of production data is available both real-time (e.g., flow rate, temperature, humidity, etc.) and off-line (e.g., goodness-of-fit (GOF), etc.) A GOF value may indicate how well a predicted measurement value from a data model represents an actual measurement value. This abundance of the production data provides an opportunity to develop a systematic performance prediction and monitoring method to capture an underlying process complexity and enhances a process control capability. Data streams (e.g., trace data, process variables data, metrology data, etc.) may change over time due to underlying process dynamics.

A current method for building a model for performance prediction and monitoring does not consider nonlinearity or nonstationarity characteristics or both commonly existing in a semiconductor manufacturing process. Nonlinearity characteristic refers to a situation where an output is not directly proportional to an input. A nonlinear system refers to a system which does not satisfy a superposition principle applied to a linear system, e.g., F(x+y+z . . . )=F(x)+F(y)+F(z) + . . . . A “stationary” process refers to a stochastic process whose joint probability distribution does not change when shifted in time or space. A “nonstationary” process refers to a stochastic process with variable probability distribution. Semiconductor manufacturing process includes, but is not limited to: deposition steps (i.e., steps for adding materials to semiconductor wafers), removal steps (e.g., etching), patterning steps (e.g., lithography), etc. Models (e.g., a known linear regression model) built by the current method do not consider nonlinearity characteristic of the semiconductor manufacturing process. Nonlinear models (e.g., a known recurrent neural network models, etc.) built by the current method need a huge amount of data (e.g., 10 terabyte, etc.) and re-training for prediction due to the nonlinearity characteristic of the semiconductor manufacturing process. Models (e.g., a known auto-regressive moving average (ARMA) model) built by the current method do not consider nonstationarity characteristic of the semiconductor manufacturing process.

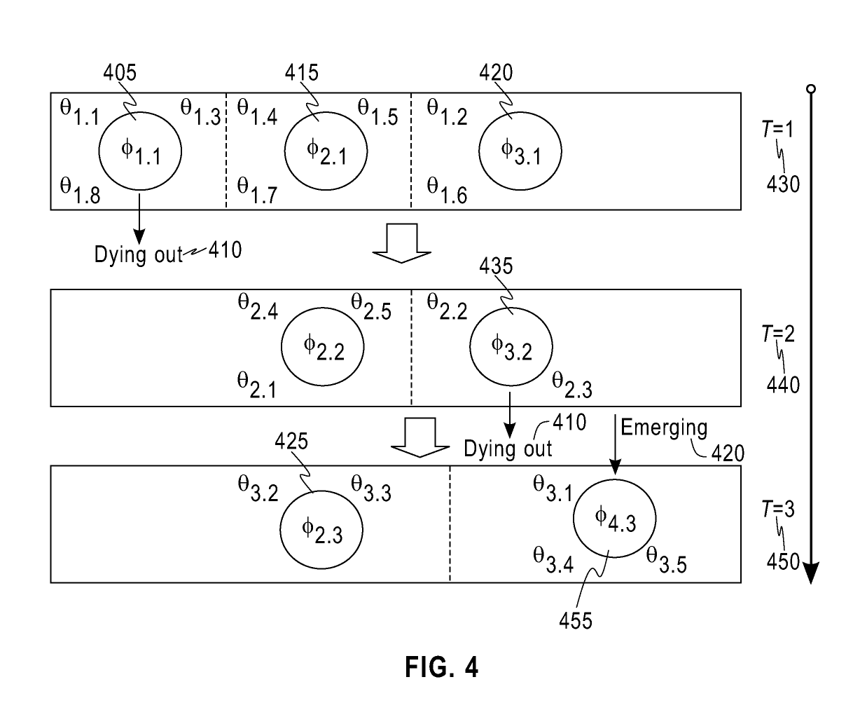

In this disclosure, there are provided a method, a system and a computer program product for continuously predicting and monitoring performance of a semiconductor manufacturing process with consideration of the nonlinearity and the nonstationarity characteristics of the semiconductor manufacturing process. A semiconductor manufacturing process includes one or more manufacturing steps, e.g., etching, chemical deposition, CMP (Chemical-Mechanical Planarization—a step for smoothing surfaces of a semiconductor wafer), which exhibit nonlinearity and nonstationarity characteristics. These one or more manufacturing steps accommodate a time-varying nature, e.g., trace data from these manufacturing steps would vary from time to time. Due to this time-varying nature, a performance model that predicts and monitors the semiconductor manufacturing process needs to be updated when a significant change is detected in new data stream (e.g., new trace data, new process variables data, new metrology data). How to detect a “significant change” in a data stream is described in detail below in conjunction with FIG. 4.

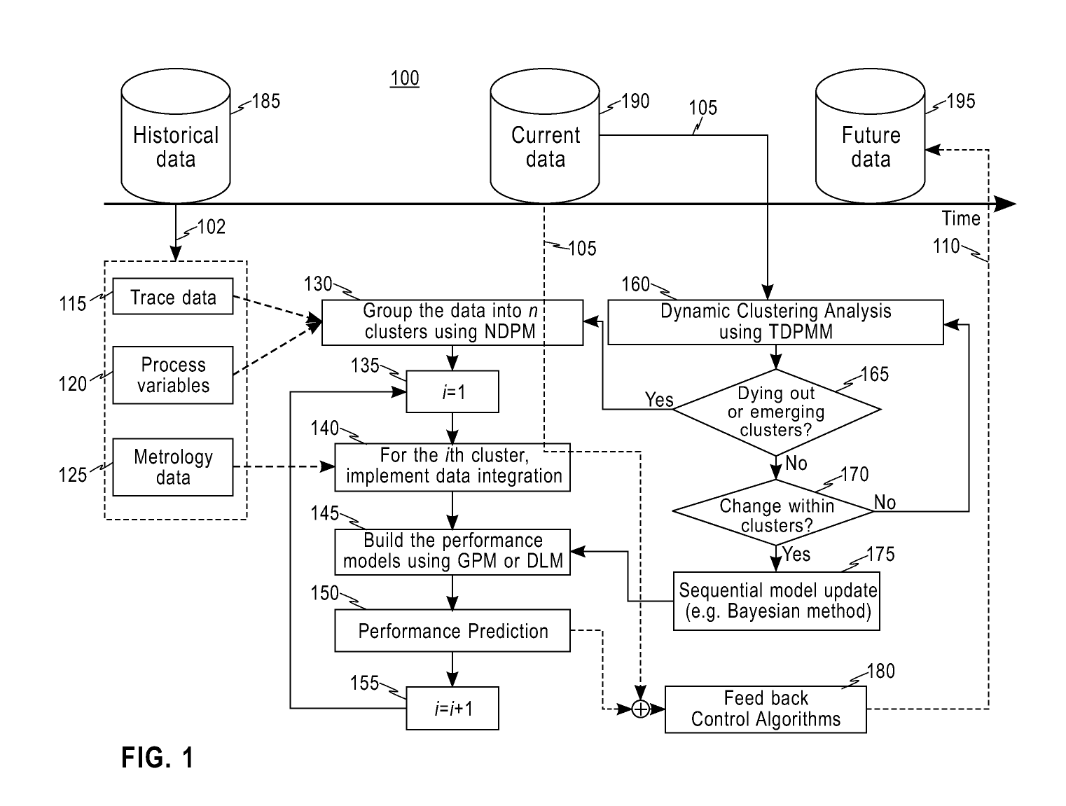

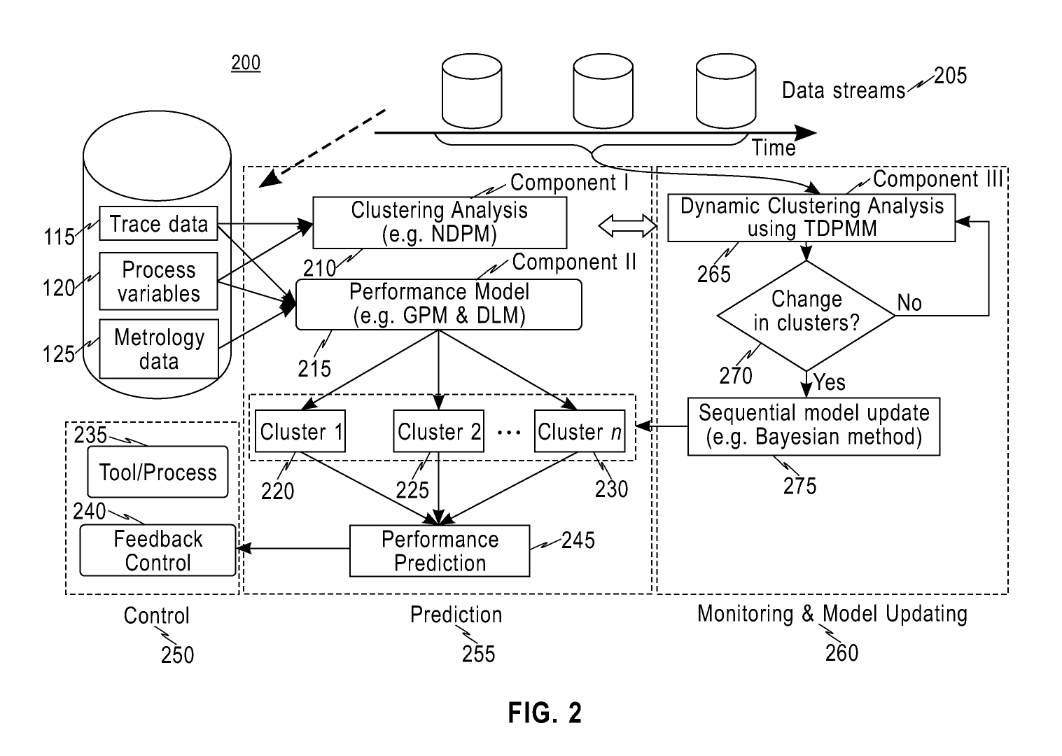

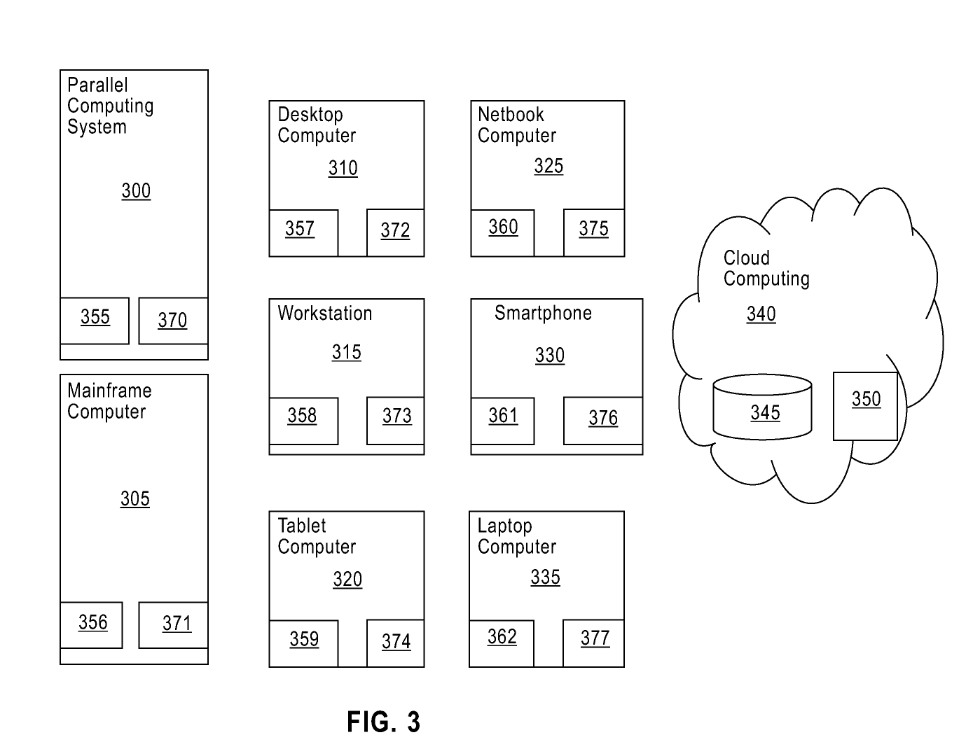

FIG. 1 illustrates a flow chart that describes a method 100 for modeling a semiconductor manufacturing process. FIG. 2 illustrates a system 200 that runs the method 100 shown in FIG. 1. The system 200 may be implemented by a computing system. FIG. 3 illustrates example computing systems that can run the method shown in FIG. 1. These computing systems may include, but are not limited to: a parallel computing system 300 including at least one processor 355 and at least one memory device 370, a mainframe computer 305 including at least one processor 356 and at least one memory device 371, a desktop computer 310 including at least one processor 357 and at least one memory device 372, a workstation 315 including at least one processor 358 and at least one memory device 373, a tablet computer 320 including at least one processor 356 and at least one memory device 374, a netbook computer 325 including at least one processor 360 and at least one memory device 375, a smartphone 330 including at least one processor 361 and at least one memory device 376, a laptop computer 335 including at least one processor 362 and at least one memory device 377, or a cloud computing system 340 including at least one storage device 345 and at least one server device 350.

In FIG. 2, the system 200 receives trace data 115, process variables data 120, and metrology data 125. These trace data 115, process variables data 120 and metrology data 125 include, but are not limited to: a historical data stream 102 (e.g., trace data, process variables data and metrology data which were already stored in a storage device or a database 185 and which were already obtained from the semiconductor manufacturing process while manufacturing a semiconductor product (e.g. a semiconductor chip, a semiconductor wafer, a semiconductor lot, etc.)).

At 130-140 shown in FIG. 1, a clustering analysis component 210 of FIG. 2 groups the received trace data, the received process variables data, the received metrology data as one or more clusters. In one embodiment, in order to group these data, the clustering analysis component 210 runs one or more of: Gaussian Mixture Model or Nested Dirichlet Process Model or the like. In one embodiment, the clustering analysis component 210 clusters the received trace data, the received process variables data, the received metrology data when a multivariate normality distribution assumption (i.e., an assumption that probability distributions of the received trace data, the received process variables data, the received metrology data are normal distributions) is violated. For example, Shapiro-Wilk test for normality is used to test if an assumption of multivariate normal distribution holds or not. According to Shapiro-Wilk test, an assumption is made that a population is normally distributed. If a p-value associated with the population is less than a threshold, e.g., 0.05, the assumption is considered to be violated. P-value refers to a probability value obtained by rejecting the assumption when the assumption is true. In one embodiment, if the assumption holds, Gaussian Mixture Model is be used for the clustering. Otherwise, NDPM is used for the clustering.

At 145 shown in FIG. 1, a performance model component 215 of FIG. 2 creates, based on the received trace data, the received process variables data and the received metrology data, a performance model of the semiconductor manufacturing process. The created performance model associates the received metrology data (e.g., goodness-of-fit metric, etc.) with the received trace data and the received process variables data. In one embodiment, the created performance model includes, but is not limited to: a non-parametric Gaussian Process Model or Dynamic Linear Model.

An example of the created performance model is as follows: nonlinear regression model for the Goodness-of-Fit (GOF) measurement of semiconductor products is represented, for example, by y=ƒ₁(X), where y is the GOF of the semiconductor products, and X includes features extracted from the received trace data and the received process variables data. ƒ₁(·)refers to any function that represents the nonlinear regression model. Another example of the created performance model is Gaussian Process Model (GPM) for the throughput of semiconductor products (the number of wafers produced per unit time), which is the performance for a semiconductor manufacturing tool or a semiconductor fab. This Gaussian Process Model can be represented, for example, by z=ƒ₂(X), where z is the throughput value and X are the features from the received trace data, from prior throughput data, and from availability times of upstream semiconductor manufacturing tools. ƒ₂(·) refers to any function that represents GPM.

For each cluster, e.g., cluster 1 (220), cluster 2 (225), . . . , cluster n (230) shown in FIG. 2, the performance model component 215 fits the created performance model to the received metrology data to associate the received metrology data with the received trace data and the received process variables data. The performance model component 215 captures, based on the fitting, the nonlinearity characteristics of the semiconductor manufacturing process. A relationship between the received metrology data and the received trace data may indicate the nonlinearity and the nonstationarity characteristics of the semiconductor manufacturing process. For example, the fitting may indicate that the received metrology data may not be directly proportional to the received trace data. In another example, the fitting may indicate that the joint probability of the received metrology data and the received trace data may indicate a variable probability process.

Returning to FIG. 1, at 150, a performance prediction component 245 shown in FIG. 2 predicts future metrics (i.e., future value of the received metrology data) of the products from the semiconductor manufacturing process. For example, if the performance model component 215 captures the nonlinearity characteristic in the semiconductor manufacturing process, the performance prediction component 245 utilizes the performance model, e.g., Gaussian Process Model, which can handle the nonlinearity characteristic in order to predict performance (e.g., throughput, yield rate, etc.) of the semiconductor manufacturing process. If the performance model component 215 captures linearity characteristic in the semiconductor manufacturing process, the performance prediction component 245 utilizes the performance model, e.g., Dynamic Linear Model, etc., which can handle the linearity characteristic in order to predict performance of the semiconductor manufacturing process. The predicted performance of the semiconductor manufacturing process includes, but is not limited to: future values of the metrology data, a future value of throughput of the semiconductor manufacturing process, a future value of yield rate of the semiconductor manufacturing process, etc. At 155, the computing system repeats 140-150 until all the clusters are processed according to 140-145. The components 210-215 and 245 are used in order to continuously predict 255 performance of the semiconductor manufacturing process.

Once a performance model is created, e.g., by using Dynamic Linear Model, etc., a linear or nonlinear relationship between a target variable y and an input variable X, y=ƒ(X) becomes known: for example, a relationship between the received metrology data and the received process variables may indicate nonlinearity characteristics. With newly collected trace data and process variable data X* 105, predicted values of future target variable (e.g., metrology data, throughput data or yield rate data) can be calculated as ŷ=ƒ(X*) , where ŷ is a vector of the predicted values. When values of y*, newly collected metrology data, throughput data, or yield rate data, are available, the performance prediction component 245 compares ŷ and values of y*. In one embodiment, these newly collected trace data, process variable data, and metrology data is stored in a storage device 190.

Returning to FIG. 1, at 180, the difference between y* and ŷ is fed back 240 to a control system 250 (FIG. 2), e.g., in real-time or off-line, in order to meet a corresponding product specification and enhance the yield rate, e.g., by adjusting values of controllable factors (i.e., process variables) of corresponding semiconductor manufacturing tool or process 235. This adjustment may result in future data 110, e.g., future process variables data, future metrology data, future trace data, e.g., by applying this adjustment to the corresponding semiconductor manufacturing tool or process 235. In one embodiment, this future data 110 is stored in a storage device 195.

When newly collected trace data, metrology data and process variables data 105 are available, a monitoring and model updating component 260 shown in FIG. 2 runs 160-175 shown in FIG. 1. The monitoring and model updating component 260 shown in FIG. 2 includes, but is not limited to: a dynamic clustering analysis component 265, a change detection component 270, and a model update component 275.

Returning to FIG. 1, by running steps 160-175, the computing system detects nonstationary characteristics of the semiconductor manufacturing process. At 160 shown in FIG. 1, the dynamic clustering analysis component 265 receives a data stream 205 shown in FIG. 2, which includes, but is not limited to: the newly collected trace data, metrology data and process variable data stored in the storage device 190 shown in FIG. 1. In one embodiment, the data stream 205 may include, but is not limited to: trace data, process variables data, and metrology data which are currently provided from sensors on the semiconductor manufacturing process or from measurements of newly manufactured semiconductor product(s). The dynamic clustering analysis component 265 runs a dynamic clustering analysis on the data stream 205 as shown in FIG. 2. The dynamic clustering analysis includes, but is not limited to: Temporal Dirichlet Process Mixture Model (“TDPMM”), or the like.

At 165-170, the change detection component 270 shown in FIG. 2 detects, based on the run dynamic clustering analysis, a first-type cluster, a second-type and a third-type cluster of the current data stream 105. The first-type cluster includes, but is not limited to: at least one cluster being phased out after the grouping at 130. The second-type cluster includes, but is not limited to: at least one new cluster emerged after the grouping at 130. The third-type cluster includes, but is not limited to: at least one existing cluster including one or more changes in the probability distribution of underlying data (i.e., the current data stream 105 and the future data stream 110), in which the one or more changes are larger than a pre-determined threshold. For the third-type cluster, one or more statistical tests can be used to detect if there is a change in the probability distribution. For example, Multivariate Two-Sample T²-Test can be used to detect a change in the probability distribution. Multivariate Two-Sample T²-Test tests whether mean vectors of two normally distributed multivariate samples are equal or not. If a result of the Multivariate Two-Sample T²-Test is greater than a threshold value T ²(α, p, n₁+n₂−2), the change detection component 270 determines that the two mean vectors are different, where α is a significance level, n₁ and n₂ are sample sizes, p is the number of features (columns) in the two samples.

The change detection component 270 evaluates, e.g., in real-time or off-line, whether a significant change has taken place in the semiconductor manufacturing process. The significant change may include, but is not limited to: a detection of the first-type cluster, a detection of the second-type cluster, or a detection of the third-type cluster.

Statistical techniques or model based change detection methods can be used to detect the significant changes in the data stream 205. Those techniques and methods include, but are not limited to: Statistical Process Control techniques, and parametric, semi-parametric or non-parametric model based change detection methods, and Temporal Dirichlet Process Mixture Model (“TDPMM”). TDPMM can model an evolution of cluster parameters and popularity over time T using any time series model, i.e. TDPMM can update the cluster parameters sequentially. FIG. 4 illustrates examples of the first-type cluster, an example of the second-type cluster, and an example of the third-type cluster. In FIG. 4, T is a time, at T=1 (430), the dynamic clustering analysis component 265 can classify the data streams 105-110 into, for example, three clusters: φ_{1.1} (405), φ_{2.1} (415), and φ_{3.1} (420). By using TDPMM, the dynamic clustering analysis component 265 can find a first-type cluster 410 φ_{1.1} (405) at time T=1 (430), another first-type cluster 410 φ_{3.2} (435) at time T=2 (440), and a second-type cluster 420 φ_{4.3} (455) at time T=3 (450). From T=1 (430) to T=3 (450), the cluster φ_{2.1} (415) evolves to become the cluster φ_{2.3} (425). At T=3 (450), the change detection component 270 compare the probability distribution of the cluster φ_{2.1} (415) and the probability distribution of the cluster φ_{2.3} (425). If the difference between these probability distributions is larger than a pre-determined threshold, the dynamic clustering analysis component 265 determines that the φ_{2.3} (425) is a third-type cluster. One or more of the first-type cluster 410, the second-type cluster 420 and the third-type cluster represents the significant change in the data streams 105-110.

Returning to FIG. 1, at 165-170, if the change detection component 270 determines that there is no significant change, i.e., there exists no first-type cluster, no second-type cluster and no third-type cluster in the data streams 105-110, then control returns to 160. If there exists at least one first-type cluster or at least one second-type cluster in the data streams 105-110, then control returns to 130. If there is no first-type cluster and no second-type cluster in the data streams 105-110 but there exists at least one third-type cluster in the data streams 105-110, control goes to 175.

At 175, the model update component 275 updates the performance model created at 145 when the significant change is detected in the clusters 220-230 of the data streams 105-110. In order to update the created performance model, the model update component 275 runs a Bayesian inference method with the created performance model and the first-type cluster, the second-type cluster and the third-type cluster. Thus, the components 265-275 are used to continuously monitor the semiconductor manufacturing process in order to detect the significant change. The components 265-275 are also used to update the created performance model upon detecting the significant change in the semiconductor manufacturing process.

In one embodiment, the components 210, 215, 240-245 and 265-275 are implemented by one or more computing systems shown in FIG. 3. In another embodiment, the components 210, 215, 240-245 and 265-275 are implemented on hardware or reconfigurable hardware, e.g., FPGA (Field Programmable Gate Array) or CPLD (Complex Programmable Logic Device), by using a hardware description language (Verilog, VHDL, Handel-C, or System C). In another embodiment, the components 210, 215, 240-245 and 265-275 are implemented on a semiconductor chip, e.g., ASIC (Application-Specific Integrated Circuit), by using a semi-custom design methodology, i.e., designing a semiconductor chip using standard cells and a hardware description language.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for modeling a semiconductor manufacturing process, the method comprising:
receiving trace data, process variables data and metrology data, obtained during the semiconductor manufacturing process;
creating, based on the received trace data, the received process variables data and the received metrology data, a performance model of the semiconductor manufacturing process, the created performance model capturing nonlinearity characteristics of the semiconductor manufacturing process; and
predicting, based on the created performance model, future values of the received metrology data,
wherein a processor coupled to a memory device performs the receiving, the creating, the predicting and the detecting.

2. The method of claim 1, wherein further comprising:
grouping the received trace data, the received process variables data, the received metrology data as one or more clusters;
for each cluster, fitting the created performance model to the received metrology data to associate the received metrology data with the received trace data and the received process variables data; and
capturing, based on the fitting, the nonlinearity characteristics of the semiconductor manufacturing process.

3. The method of claim 2, wherein the grouping uses Gaussian Mixture Model or Nested Dirichlet Process Model.

4. The method of claim 1, further comprising:
detecting a significant change in the semiconductor manufacturing process, the significant change representing nonstationality characteristics of the semiconductor manufacturing process;
updating the created performance model when the significant change is detected in the semiconductor manufacturing process.

5. The method of claim 4, wherein the detecting the significant change comprises:
running a dynamic clustering analysis on the newly collected and received metrology data, the newly collected and received trace data and the newly collected and received process variables data;
detecting, based on the run dynamic clustering analysis, a first-type cluster, a second-type and a third-type cluster of the newly collected and received metrology data, the newly collected and received trace data and the newly collected and received process variables data, the first-type cluster including at least one cluster being phased out after the grouping, the second-type cluster including at least one new cluster emerged after the grouping, the third-type cluster including significant changes in the probability distribution of the data in at least one existing cluster,
wherein the significant change is the first-type cluster, the second-type cluster and the third-type cluster.

6. The method of claim 4, wherein the updating the created performance model comprises:
running a Bayesian method with the created performance model and the first-type cluster, the second-type cluster and the third-type cluster.

7. The method of claim 5, wherein the dynamic clustering analysis uses Temporal Dirichlet Process Mixture Model.

8. The method of claim 1, wherein the created performance model is a non-parametric Gaussian Process Model or a Dynamic Linear Model.

9. The method of claim 1, wherein a relationship between the received metrology data and the received trace data and received process variables data indicates the nonlinearity and the nonstationarity characteristics of the semiconductor manufacturing process.

10. The method of claim 4, wherein the predicting the future value of the metrology data uses Gaussian Process Model or Dynamic Linear Model.
